(19) United States
(12) Patent Application Publication
(10) Pub. No.: US 2011/0213665 A1
(43) Pub. Date: Sep. 1, 2011

(54) Bank Based Advertising System

(75) Inventors: David Joa, Irvine, CA (US); Kurt D. Newman, Matthews, NC (US); Timothy James Mark, Berkeley, CA (US); Srinath Nagarajan, Waltham, MA (US); Sandra Adele Weiner, Wayne, NJ (US)

(73) Assignee: BANK OF AMERICA CORPORATION, Charlotte, NC (US)

(21) Appl. No.: 12/714,101

(22) Filed: Feb. 26, 2010

(51) Int. Cl. G06Q 30/00; G06Q 40/00

(52) U.S. Cl. 705/14.61; 705/14.72; 705/14.49; 705/35

(57) ABSTRACT

Embodiments of the invention include apparatuses, methods, and computer-program products that provide for a unique bank-based advertising system. In one embodiment, the bank-based advertising system receives an authentication request from a user. The system then compares information received with the authentication request to authentication information stored in a memory system to determine that the user is a customer of the bank and has access to a financial account maintained by a bank. The system then provides the user with access to a bank-based advertising system based at least partially on the determination that user is a customer of the bank and has access to the financial account. The system then allows the user to use the bank-based communication system to create an advertisement on behalf of an owner of the financial account for which the user was authenticated. The system then presents the advertisement through one or more banking outlets.

### FIELD

Embodiments of the invention relate generally to advertising systems and methods and/or other communication systems and methods.

### BACKGROUND

Currently, banks provide financial services for customers. Banks, however, are constantly searching for ways to increase customer service and community engagement.

Other businesses are also constantly searching for ways to increase customer service and to advertise more effectively to customers and potential customers. In fact, people generally are constantly looking for new and unique ways to communicate with one another. However, with so much information being presented to people these days and with the prevalence of scams, frauds, phishing schemes, and/or the like mixed in amongst all this information, people desire to receive only communications that are of particular interest to them and that are relatively free of scams, frauds, and/or the like.

### BRIEF SUMMARY

Embodiments of the present invention address these problems and/or other problems with an innovative communication system and method. More particularly, the inventors of the present invention have identified that a bank can often be in a unique position to help businesses communicate with customers or, more generally, help one entity communicate with another entity, due to the fact that a bank can interact with so many people and businesses on a regular basis and the fact that a bank is often set-up to authenticate the identity of the people and businesses with which it interacts. As such, the inventors disclose herein apparatuses, methods, and computer program products for providing for bank-based communication, such as bank-based advertising. For example, in one embodiment of the invention, an electronic advertising system is provided that allows a user to use a payment device (e.g., a bank-issued credit or debit card) and/or other bank-provided authentication procedures to access a tool that allows the user to create advertisements, offers, and/or the like for display to the bank's customers and/or the public generally. Embodiments of the present invention may allow a customer that has a business account with a bank to create advertisements to display at banking centers (e.g., bank branches, ATMs, bank websites, etc.) within certain geographic areas or communities. The payment device and/or other bank-provided authentication procedures can enable the bank to identify the person creating the advertisement as a person having the authority to create an advertisement for the particular business associated with the bank account.

The following presents a simplified summary of one or more embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide an apparatus for providing a bank-based advertising system. In one embodiment, the apparatus includes: an input interface configured to receive input; an output interface configured to provide output; a memory system comprising authentication information for a plurality of customers of a bank, wherein the authentication information for a customer includes information that the customer can use to authenticate the customer's identity when the customer attempts to access a financial account associated with the customer and maintained by the bank; and a processor operatively coupled to the input interface, the output interface, and the memory system. In some such embodiments, the processor is configured to: use the input interface to receive an authentication request from the user, compare information received with the authentication request to authentication information stored in the memory system to determine that the user is a customer of the bank that is authorized to use the bank-based advertising system, allow the user to create an advertisement using the bank-based advertising system, and present the advertisement to others using the output interface.

In some embodiments of the apparatus, the information received with the authentication request includes a user identification code and a passcode, and the processor is configured to compare the user identification code and the passcode to a user identification code and passcode that the user can use to access the user's financial account online. In some embodiments of the apparatus wherein the information received with the authentication request includes information read from a payment device held by the user.

In some embodiments of the apparatus, the processor is further configured to use the output interface to provide the user with a graphical user interface comprising an advertisement creation tool. In some such embodiments, the advertisement creation tool includes a tool for allowing the user to upload content for the advertisement. In some such embodiments, the advertisement creation tool includes a tool for allowing the user to specify an audience for the advertisement. In some such embodiments, the advertisement creation tool includes a tool for allowing the user to specify a geographic region in which the advertisement is to be presented.

In some embodiments of the apparatus, the processor is further configured to: determine a community associated with the advertisement; and use the output interface to present the advertisement to the community. In some such embodiments, the community associated with the advertisement includes a geographic region, and the processor is configured to use the output interface to present the advertisement to the community by presenting the advertisement using presentation devices located within the geographic region. In other such embodiments, the community associated with the advertisement includes a group of bank customers. In some embodiments, the processor is configured to determine the community associated with the advertisement based at least partially on user input. In some embodiments, the processor is configured to determine the community associated with the advertisement based at least partially on transaction data maintained by the bank.

In some embodiments of the apparatus, the apparatus further includes a plurality of display devices located at a plurality of banking centers and communicably coupled to the output interface. In such embodiments, the processor is configured to present the advertisement to others using the output interface by presenting the advertisement using at least some of the plurality of display devices. In some embodiments, the processor is configured to present the advertisement to others using the output interface by displaying the advertisement on an automated teller machine display, a bank website, an electronic bank statement, a paper bank statement, or an electronic bulletin board located in a bank branch.

In some embodiments, the advertisement is a notice, offer, promotion, sale, coupon, or discount. In some embodiments of the apparatus, the processor is configured to compare the advertisement to a plurality of rules to determine whether the advertisement contains inappropriate content.

In some embodiments of the apparatus, the processor is further configured to: determine that the information associated with the authentication request authorizes the user to access a business account associated with a business; and allow the user to create an advertisement on behalf of the business based at least partially on the determination that the information associated with the authentication request authorizes the user to access a business account. In some such embodiments, the processor is further configured to: receive user input from the user, the user input comprising an indication of one or more other bank customers; and allow, based at least partially on the user input, the one or more other bank customers to create or modify an advertisement on behalf of the business based on the user input.

In some embodiments of the apparatus, the processor is configured to: receive user input from the user, the user input comprising an indication of a time period for presenting the advertisement, and use the output interface to present the advertisement based at least partially on the indication of the time period for presenting the advertisement. In some embodiments, the processor is configured to assess a fee for presenting the advertisement. In some such embodiments, the processor is configured to determine the fee based on a number of times or length of time that the advertisement is presented, viewed, or accessed. In some embodiments of the apparatus, the processor is configured to: use the input interface to receive input from a recipient of the advertisement; and use the output interface to provide the recipient with additional information associated with the advertisement in response to the input received from the recipient.

Embodiments of the present invention further provide a computer-implemented method involving: (1) receiving an authentication request from a user; (2) comparing information received with the authentication request to authentication information stored in a memory system to determine that the user is a customer of the bank and has access to a financial account maintained by a bank; (3) providing the user with access to a bank-based communication system based at least partially on the determination that the user is a customer of the bank and has access to the financial account; (4) allowing the user to use the bank-based communication system to create content on behalf of an owner of the financial account; and (5) presenting the content to one or more other bank customers.

Embodiments of the present invention further provide a computer program product comprising a non-transitory computer readable medium having computer executable program code embodied therein to provide a bank-based advertising system. In one embodiment, the computer executable program code includes: (1) a computer executable code portion configured to receive an authentication request from a user; (2) a computer executable code portion configured to compare information received with the authentication request to authentication information stored in a memory system to determine that the user is a customer of the bank and has access to a financial account maintained by a bank; (3) a computer executable code portion configured to provide the user with access to a bank-based communication system based at least partially on the determination that the user is a customer of the bank and has access to the financial account; (4) a computer executable code portion configured to allow the user to use the bank-based communication system to create content on behalf of an owner of the financial account; and (5) a computer executable code portion configured to present the content to one or more other bank customers.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a method for creating a bank-based advertising system, in accordance with some embodiments of the invention;

FIG. 2 is a flow chart of a method for storing content from an authenticated user in a bank-based advertising system, in accordance with some embodiments of the invention;

FIG. 3 is a flow chart of a method for presenting content in a bank-based advertising system, in accordance with some embodiments of the invention;

FIG. 4 is a block schematic diagram of an exemplary system for a bank-based advertising system, in accordance with some embodiments of the invention;

FIG. 5 is an example of an exemplary commercial embodiment of a bank-based advertising system, in accordance with some embodiments of the invention; and

FIG. 6 is an example of a graphical user interface for a bank-based advertising system, in accordance with some embodiments of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wireline, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment, an entirely software embodiment (including firmware, resident software, micro-code, etc.), or an embodiment combining software and hardware aspects that may generally be referred to herein as a “module,” “application,” or “system.”

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

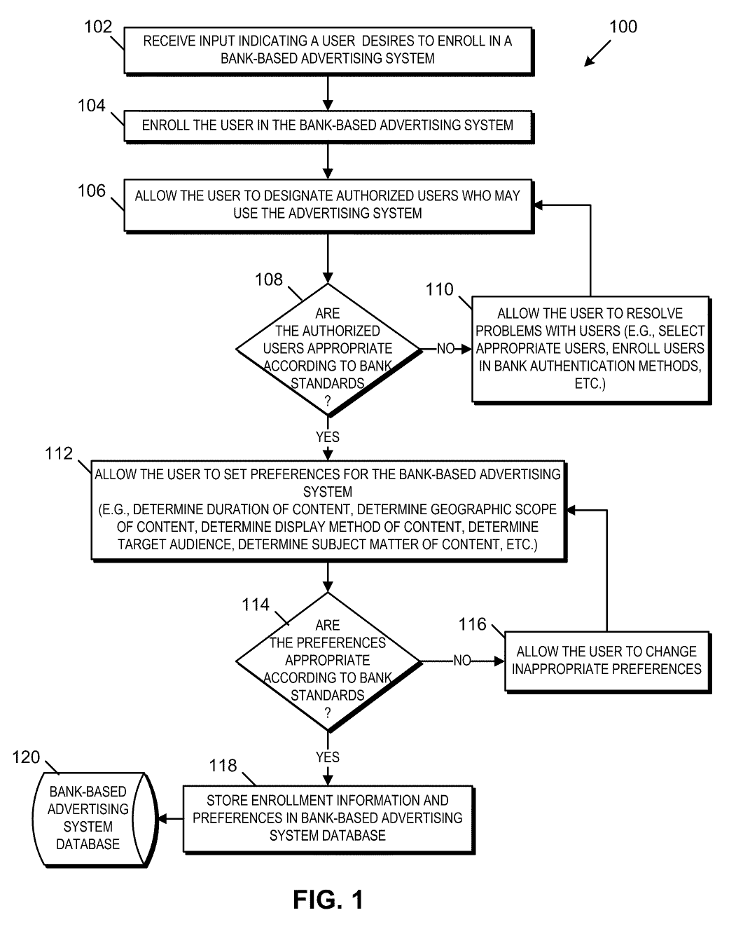

As illustrated in FIGS. 1-6, aspects of the present disclosure include methods, apparatuses, and computer program products directed to a bank-based communication system, such as a bank-based advertising system. It will be appreciated that, although embodiments of the present invention are generally described herein in the context of advertising, other embodiments of the invention may be adapted to create, communicate, and/or portray other types of communications from a bank customer to another customer or to a member of the public.

In one embodiment of the invention, a bank-based advertising system provides systems and methods of increasing community engagement between a bank and the bank's customers. A bank-based advertising system allows a bank to provide a service to the bank's customers by providing a media channel or content outlet that a bank customer may use. For example, the bank is able to authenticate the identity of the customer using bank-specific data and/or authentication procedures, receive content from the authenticated customer, and present the content using one or more output devices. Accordingly, the bank-based advertising system provides a tool for community engagement between the bank and the bank's customers by providing information and enhanced service to the customers. Creation, management and presentation of advertisements using the bank-based advertising system is discussed in more depth below with regard to FIGS. 1-6.

FIG. 1 is a flow chart of an example of a method 100 for creating and maintaining a bank-based advertising system in accordance with an embodiment of the present invention. In block 102, the bank receives an indication that a user desires to enroll in a bank-based advertising system. For example, the indication may be verbal (e.g., in person) or non-verbal (e.g., via an online banking system). The user may make the indication directly to the bank or to a third party that is associated with the bank. The indication is received in person, over the phone, via a computer system, via an email or via an online form transmitted over a network (e.g., an online banking system), through the postal system, or in any other manner. It should be understood that the user, as used herein, may be a customer of the financial institution, a person associated with a customer of the financial institution, or not a current customer of the financial institution, such as a potential customer. For example, in one embodiment, the user is a current customer of the financial institution such that the financial institution already has mechanisms and procedures in place to authenticate the identity of the customer (e.g., by way of online banking authentication procedures, ATM authentication procedures, etc.).

In block 104 the user is enrolled in the bank-based advertising system in response to the customer accepting enrollment terms and/or other terms. In one embodiment, the user indicates a desire to enroll in the bank-based advertising system offered by the user's financial institution (or other entity) and the user is enrolled in the bank-based advertising system through a website or other means. It should be understood that the user may enroll in the bank-based advertising system in any manner in which the user is able to communicate with the bank, in addition to those methods set forth herein.

In block 106, in some embodiments, the provider of the bank-based advertising system allows the user to designate authorized users who may use the advertising system. Authorized users are individuals who can authenticate their identity to the bank and gain access to the bank-based advertising system. In some embodiments, the user designates who is allowed to access the bank-based advertising system, input content, change content, or change preferences. For example, if the user is the CEO of a business the user may designate himself and certain other individuals associated with his business as authorized users. In another example, an individual running for a local political office may designate herself and certain members of her campaign staff as authorized users. The user may designate as many or as few authorized users as desired.

In some embodiments, all authorized users must be customers of the bank either via the bank maintaining authorized user's financial account or via the authorized user having access to the business's financial account (e.g., having a bank card tied to the business's financial account). Embodiments of the invention that require all authorized users to be customers of the bank may do so in order so that the authorized users can be authenticated using the bank's authentication procedures before accessing the bank-based advertising system.

As will be discussed later, the user may change the authorized users. In another embodiment, the user may set different levels of access to the bank-based advertising system for authorized users. For example, the user may designate some authorized users as having full access rights to the bank-based advertising system and other authorized users as having limited access rights, such as the ability to upload content but not change preferences.

Turning now to decision block 108, in some embodiments of the invention, the provider of the bank-based advertising system determines whether the authorized users are appropriate according to bank standards. For example, the bank may evaluate the authorized users to determine whether the bank has methods for authenticating the users' identities, determine whether the authorized users are of an appropriate age, or determine whether the authorized users have an appropriate relationship to the user or the bank. It should be understood that authorized users may be evaluated based on different criteria than those disclosed herein. Thus, the aforementioned criteria for determining whether an authorized user is appropriate according to bank standards are not limiting. If the authorized users are determined to be inappropriate according to bank standards, the bank-based advertising system turns to block 110. If the authorized users are determined to be appropriate, the bank-based advertising system turns to block 112.

In block 110, the provider of the bank-based advertising system allows the user to resolve problems with the desired authorized users that made them inappropriate. For example, the authorized users selected by the user may need to enroll in bank authentication methods such by acquiring a bank card, a bank website login, an ATM PIN (personal identification number), a password, a secret code, a graphical identifier, a security question and answer, a fingerprint scan, an iris scan, or another mechanism that can be used to authenticate the user's identity. In another example, the authorized users selected by the user may be too young to have access to the bank-based advertising system and therefore the user will select a different authorized user of appropriate age. In another embodiment, the bank may suggest potential authorized users based on bank-specific information, such as all of the people currently having some kind of access to a particular business's account or other shared account. In another example, certain users are determined by the bank to be inappropriate based on past financial activity with the bank. For example, is a person is known to have engaged in fraudulent financial activity in the past, the bank may determine that the person is not permitted to access the bank-based advertising system.

In block 112, the provider of the bank-based advertising system allows a user to set preferences for the bank-based advertising system. The user is allowed to input preferences and/or settings for the bank-based advertising system that enables the user to customize the bank-based advertising system for his particular needs. In some embodiments, these preferences and/or settings relate to management of the bank-based advertising system. For example, such preferences and/or settings may regulate various operations of creating, managing and presenting the bank-based advertising system to the user, such as what types of data to include in the bank-based advertising system database, preferences relating to content characteristics, preferences relating to content presentation (e.g., target audience or target communities), preferences relating to fees associated with the bank-based advertising system, preferences relating to authorized users, or any other preferences and/or settings appropriate to customize the bank-based advertising system. Many different types of preferences and/or settings are also possible and the present invention should not be limited to the above-recited customization options. In one embodiment, all of the user's preferences and/or settings are selected by the user with no guidance from the bank-based advertising system provider. In another embodiment, one or more preferences and/or settings are suggested by the bank-based advertising system provider and may be based on data owned by the provider of the bank-based advertising system or default settings.

In another embodiment, the bank-based advertising system provider suggests preferences based on bank-specific data. For example, the bank may suggest that a small business owner display advertisements in a specific bank branch because bank-specific data indicates that bank customers at that branch have made purchases from the small business already. In another example, the bank may suggest preferences and/or settings based on other bank data obtained by virtue of the business's account with the bank, such as data pertaining to the type of business, the age of the business, the location(s) of the business, the number of employees, the number of people with access to the business's financial account, the number of customers, the volume of transactions, the volume of customers, the size of individual sales, the cost of products, variations in the rate of transactions, the volume of returns, the popularity of previous promotions, the location of customers, shopping habits of customers, the number of repeat customers, the number of first-time customers, and/or the like. Much of this information can be gathered by a bank from transaction information associated with the business's financial account maintained by the bank and, therefore, the bank is in a unique position to suggest advertising preferences and/or settings to the business.

Turning now to decision block 114 the bank-based advertising system provider determines whether the user preferences are appropriate according to bank standards. For example, the provider may evaluate the target audience preferred by the user and determine that the audience is inappropriate for the user's content. In another example, the provider may determine that the preferred target communities for the content is inappropriate, such as when a local business prefers to display content in a non-local community. In some embodiments, the bank-based advertising system provider compares the user's preferences to other participants in the bank-based advertising system to determine whether the preferences are inappropriate. For example, the provider may evaluate a user's preferred display method for content, such as via an ATM, in comparison to other participants. It should be understood that the provider of a bank-based advertising system may determine whether user preferences are appropriate based on many different criteria and the above-listed criteria are not limiting. If the provider determines that the preferences are inappropriate, the method for a bank-based advertising system turns to block 116. However, if the provider determines that the preferences are appropriate, the method turns to block 118.

In block 116, in some embodiments the bank-based advertising system provider allows a user to change inappropriate preferences. The bank-based advertising system provider receives input from the user to change the inappropriate preferences. As discussed above and in block 114, user preferences may be inappropriate for many different reasons. Here, the provider gives the user an opportunity to change those preferences so that they are appropriate. For example, the user may input an appropriate target audience for the user's content in response to being notified by the provider that the initial preferences were inappropriate. In another example, the user may change the preferred target communities of content presentation so that the communities are considered appropriate by the provider.

Turning now to block 118, the bank-based advertising system provider stores the user's enrollment information and preferences in a bank-based advertising system database, as illustrated in block 120. In some embodiments, the bank-based advertising system database is a database that is owned by the user's financial institution. In other embodiments, the bank-based advertising system database is a database that is owned by one or more financial institutions other than the financial institution creating and managing the bank-based advertising system. According to various embodiments, the bank-based advertising system database includes user data regarding the user's bank accounts, transactions, requests, enrollment information, preferences, demographic information, and/or the like. The user data may remain in the bank-based advertising database permanently or be removed at some point. For example, the user data may be removed from the database upon the user's request, when the user leaves the bank-based advertising system, when the content relating to the data expires, after a pre-defined period of time, or at any other time. Any type of user data gathered and/or received by the bank-based advertising system and described herein may also be present in a bank database.

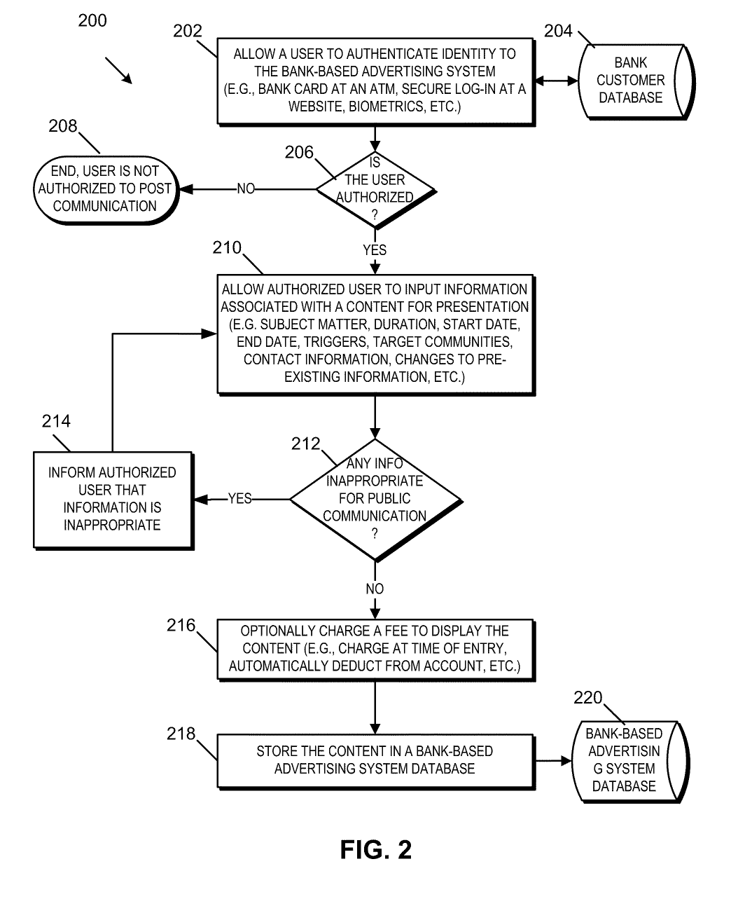

Turning now to FIG. 2, FIG. 2 illustrates a method 200 for storing content from an authenticated user in a bank-based advertising system in accordance with some embodiments. In block 202, the provider of a bank-based advertising system authenticates the identity of a user. A user's identity is authenticated when the provider determines that the user is authorized to access the bank-based advertising system. Authentication is often important to the bank-based advertising system because some embodiments of the bank-based advertising system permit user's to create advertisements (including, for example, promotions, offers, sales, coupons, and/or the like) in the name of businesses, and these advertisements can be binding on the business. Therefore, it is often important to accurately authenticate a user as being a person authorized to use the bank-based advertising system on behalf of a particular business.

In one embodiment, the bank-based advertising system provider authenticates the user's identity using bank authentication procedures (i.e., authentication procedures established by the bank to allow users to access financial accounts or engage in financial transactions involving the bank). Such a system may be advantageous because it uses the bank's robust authentication system to ensure that content is created only by authorized individuals and because it does not require the user to create and remember new authentication codes and procedures. For example, in one embodiment, the bank-based advertising system allows a user to be authenticated into the system for purposes of creating advertisements or other content using the same authentication codes, procedures, and/or systems that the user uses to log into the user's online banking account. In one such embodiment, the user authentication involves the user entering a login ID (identification) and a passcode. The authentication may also involve the authentication system checking the user's computer for cookies or other codes stored thereon that indicate that the user has accessed the bank-based advertising system or the online banking system from the particular computer in the past. Some embodiments also involve the online banking system authenticating itself to the user by, for example, showing a user-selected secret graphical image or other passcode and the user confirming that the graphical image or other passcode is correct. In some embodiments, the authentication procedure involves other authentication mechanisms in addition to or as an alternative to those described above. For example, the authentication procedures may involve: (1) one or more security questions, which may include static and/or dynamic questions and/or “out-of-wallet” questions; (2) one or more biometric scans, such as a fingerprint scan, an iris scan, a facial scan, etc.; and/or (3) the reading of machine-readable code from one or more payment devices, such as the reading of a magnetic stripe from a bank card (i.e., a credit, debit, ATM, card, or the like) or the reading of information stored on a near-field-communication (NFC) device, a radio frequency identification (RFIS) tag, or other mobile device. For example, in one embodiment, the bank-based advertising system can be accessed by a user via an advertising system kiosk located, for example, in a bank branch. In such an embodiment, the kiosk may require that the user authenticate himself/herself by, for example, swiping the user's bank card through a bank card reader and then using the kiosk's keypad or other user input device to enter a PIN (personal identification number/code) associated with the user's bank card.

In another embodiment, the provider authenticates the user's identity using bank-based advertising system specific authentication procedures. For example, bank-based advertising system specific authentication procedures may include biometric scans, hardware devices and/or software programs, linkages between the user's personal electronic devices and a bank network, or other procedures. The bank-based advertising system provider may authenticate the user's identity by any of these procedures, by only one of these procedures, or by any combination of these procedures. As discussed previously, in some embodiments, a user sets preferences as to how authorized users authenticate their identity. It should be understood that the procedures for authenticating a user's identity are varied in the examples listed herein are not limiting unless expressly recited in the claims. For example, in still another embodiment a bank authenticates a user's identity in connection with a general bank customer database as illustrated in block 204.

Turning now to block 204, in some embodiments the bank-based advertising system is connected to a bank customer database. The bank customer database is the general database of customer information that the bank maintains to perform standard banking operations. In some embodiments, the bank-based advertising system is directly connected to the bank customer database. For example, the bank-based advertising system may be integral with the bank customer database so that the bank-based advertising system has full access to all data in the bank customer database. In another embodiment, the bank-based advertising system has limited access to the bank customer database. For example, the bank-based advertising system may only have access to the data in the bank customer database necessary to authenticate the user's identity. In still another embodiment, the bank customer database itself is used to authenticate the identity of the user. For example, a user may log-in at a bank website and the bank customer database is referenced to determine whether the log-in credentials are correct.

In decision block 206, the provider determines whether the user is authorized to access the bank-based advertising system. In some embodiments, the provider determines whether the user is authorized by comparing the identity of the user determined in block 202 to the individuals authorized to access the bank-based advertising system. For example, when a bank customer logs into an ATM using his bank card, the bank-based advertising system may determine the user's identity and determine whether the user is authorized to access the bank-based advertising system. In another embodiment, the individuals authorized to access a bank-based advertising system are determined in advance by the user. For example, a user may enroll in a bank-based advertising system and designate three other users as authorized to access the bank-based advertising system for the enrolling user. In yet another embodiment, the authorized individuals are determined upon activation of the bank-based advertising system. The bank-based advertising system may be activated by an individual logging into an ATM, an individual logging into a website such an online banking website, or an individual logging into a kiosk associated with the bank-based advertising system. In some such embodiments, individuals are identified upon activation of the system and a determination is made regarding whether the individuals are authorized users. For example, the determination may be made based on criteria set by the enrolling user, such as any individuals that receive a paycheck from the enrolling user are authorized users, or the determination may be made by the bank, for instance when the bank determines that an individual is related to the enrolling user. If the provider determines that the user is not authorized, the bank-based advertising system proceeds to block 208 and may end. The non-authorized user may still be able to conduct typical banking activities, such as using an ATM or logging into a bank website, but is unable to upload or change content and/or preferences in the bank-based advertising system. If the provider determines that the user is authorized, the bank-based advertising system proceeds to block 210.

Turning now to block 210, the bank-based advertising system provider allows an authorized user to input information associated with content for presentation. In some embodiments, content is any information that is presented in a bank-based advertising system. In some embodiments, content is visual, audio, or both. In some embodiments, content is a communication from a bank customer or a non-bank associated individual or group. For example, content may be an advertisement (including an offer, promotion, coupon, and/or the like), a notice, an announcement, a message, or any other sort of communication. For example, the content may be an advertisement for a sale that a bank customer's business is having in the community or an advertisement for an event that a business or other organization is hosting.

In block 210, information associated with the content for presentation may include any characteristics of the content that affects the presentation. In some embodiments, the information associated with the content is the subject matter of the content, the body of the content, the start date that the content should be presented, the date that the content expires, target communities, the presentation methods, how the content will be paid for, and any changes from the initial user preferences. For example, a user may upload advertising content relating to his company's sale. In this example, the user would upload the text of the advertisement, the date upon which this sale will be presented through the bank-based advertising system, the last date of presentation, how the content will be presented such as via the bank website or an electronic bulletin board in a bank branch's lobby, who the preferred audience is for the content (e.g., demographics of a target audience), and any other information relating to the advertisement.

In some embodiments, the content generated using the bank-based advertising system includes a community discount where a promotion is offered to a particular community of people and a reward is provided to the community based on the community's aggregate acceptance of the promotion.

As previously discussed, the bank-based advertising system increases community engagement by allowing bank customers to share information with one another through a bank-mediated content channel. Further, it should be understood that the customization options disclosed herein do not limit the customization options possible in a bank-based advertising system. Other information may be input into the bank-based advertising system to customize a user's content. For example, the user may also be able to input contact information relating to the user that is then directly available through the content channel when the user's content is presented.

In some embodiments of block 210, the user is able to select triggers for the user-defined content. A trigger is an event that causes content to be presented. In some such embodiments, a triggering event occurs when the bank identifies a recipient of the content and determines that the recipient meets the user-selected triggering criteria for the content. For example, a user may desire that the user's political campaign advertisement be presented to any person that the bank is able to identify as having given money to the user's political party. In this example, the bank may identify recipients through an ATM or website login and determine that the recipient gave money to a political party based on transactions in the recipient's bank account. In another example, a user may desire that the user's advertisement for a sale be presented to only those individuals who have already made purchases at the user's small business, which the bank may be able to determine from transaction data that the bank has access to for transactions involving the user's small business and the bank. As the bank-based advertising system is a tool for increasing community engagement, the ability for a user to gain value from the bank data by targeted content presentation increases the system's value to the community. Therefore, it should be understood that the triggers described herein are only examples of the variety of triggers that are possible in a bank-based advertising system to allow the customer to target content to recipients.

In some embodiments of block 210, the bank-based advertising system provider allows an authorized user to select target communities for the content. In an embodiment, a target community is a geographic region in which the user desires the content to be presented. For example, the user may request that the content be presented within a state, within a county, within a city, or within any other region that may be geographically defined. A target community may be the local community in which the bank or a particular bank branch is located. In another embodiment, a target community is a group of individuals that have a common characteristic. For example, the user may request that his content be presented to only individuals with a checking account balance of greater than $20,000. Other characteristics for defining a group of individuals are possible because the bank customer database includes extensive data on bank customers. As such, characteristics defining groups of individuals can be determined from the bank customer database and used to define a target community. Of course, the bank will comply with any privacy laws, rules, regulations, and/or agreements when using customer information. Furthermore, in some embodiments, the bank obtains consent from customers to use their information in this way. In some embodiments, customer transaction information is used, but is done so in a way that individual transactions and the customers making those transactions remain anonymous and cannot be discerned by any user of the bank-based advertising system.

In some embodiments of block 210, the bank-based advertising system provider allows an authorized user to select methods of presentation for the content. As will be discussed later, in various embodiments content is presented through bank-affiliated devices. For example, content may be presented through an ATM, a website, an electronic bulletin board, or other bank-affiliated device. When a user is uploading or changing information relating to content he may designate through which devices the content should be presented. For example, the user may desire his content to be presented in electronic bulletin boards in bank branch lobbies within a particular municipality. Alternatively or additionally, the user may desire his content to be presented on the bank website, on a bank ATM, on an electronic billboard on the exterior of an ATM or bank building, in people's online or paper bank statements, and/or the like. The ability to customize the content presentation is another example of the community engagement capabilities of the bank-based advertising system.

In some embodiments, the content generated using the bank-based advertising system is displayed on a banking center community display, such as an electronic billboard in the lobby of a bank branch. U.S. patent application Ser. No. ______ to Joa et al., entitled “Banking Center Community Display,” and filed concurrently herewith, describes such banking center community displays in greater detail and is hereby incorporated by reference in its entirety.

In some embodiments, the content generated using the bank-based advertising system is displayed in a bank-based online local community hub, such as a portion of an online banking website where a customer can go to view information about local businesses and/or local events. U.S. patent application Ser. No. ______ to Nagarajan et al., entitled “Individual Customer Community Hub,” and filed concurrently herewith, describes such a bank-based local community hub in greater detail and is hereby incorporated by reference in its entirety.

In some embodiments, the content generated using the bank-based advertising system is displayed in a bank-based online business community hub, such as a portion of an online banking website where a business can go to view business community information such as information about suppliers, local markets, competitors, and/or the like. U.S. patent application Ser. No. ______ to Nagarajan et al., entitled “Business Customer Community Hub,” and filed concurrently herewith, describes such a bank-based business community hub in greater detail and is hereby incorporated by reference in its entirety.

As discussed above, numerous embodiments of block 210 are possible. The examples and embodiments included herein do not limit the content presentation customization. The authorized user is able to input information of various types associated with content. By allowing customization by a user and providing value through use of bank-specific data, the bank-based advertising system provides a personalized media channel for bank customers.

Turning now to decision block 212, the provider of the bank-based advertising system determines whether any of the information input by the user is inappropriate for public communication. In an embodiment, the provider compares all of the information input by the user against standards developed by the provider for content appropriate for public communication. For example, the provider may evaluate the text of the content to determine whether any language is inappropriate for public display. In another example, the provider evaluates the content to determine whether the triggering events are appropriate. Other examples of how content may be inappropriate include that a triggering event may be inappropriate if the content is inappropriate for the individuals targeted for that content, that a geographic community may be inappropriate if the content is unrelated to the community, that the start date of the content is too far in the future, or any other reason why content would be inappropriate for public display in a bank-based advertising system. If the provider determines that any of the information input by the user is inappropriate for public communication the method proceeds to block 214. If, however, the provider determines that all of the information is appropriate for public communication the method proceeds to block 216. In some embodiments, the bank-based advertising system determines whether any of the information input by the user is inappropriate for public communication automatically using a computer and based on pre-defined rules that define inappropriate content. In other embodiments, this step is completed by human reviewers. In still other embodiments, a combination of automated and human review is used.

In block 214, the bank-based advertising system provider informs the authorized user that the information is inappropriate. In some such embodiments, the user is allowed to modify the information and input it again for inclusion in the bank-based advertising system. In some embodiments, the bank suggests how the user may modify information to make it appropriate for public communication. For example, the bank may determine that information is inappropriate for the geographic community selected by the user but suggest another geographic community where the content would be appropriate based on bank-specific data. In another example, the bank-based advertising system may highlight for the user an inappropriate word or graphic in the content and suggest that the word or graphic be removed or modified. In some embodiments, input of inappropriate content or repeated input of inappropriate content by the same user may result in the user losing his authorized status.

Turning now to block 216, in some embodiments of the invention, the bank-based advertising system provider charges a fee to present the content. The fee can be based upon the type of content, a type of user, the duration that the content will be presented, the number of times the content is presented, the location in which the content will be presented, the method by which the content will be presented, or based on any other characteristic of the content. The content may be paid for at the time of input into the bank-based advertising system, in advance, each time the content is presented, each month, each year, or any other frequency related to content input and/or presentation. The fee may be deducted automatically from the user's bank account, the user's business bank account, or billed to the user or the user's business. The fee may be credited to the bank, to another account of the user, to a nonprofit organization, or to any other entity determined by the bank or user. In one embodiment, the fees collected by the bank or other provider through the bank-based advertising system are reinvested into the community. For example, fees collected from businesses and other users located in a particular town may be reinvested by the bank into that particular town. The reinvestments may be to such community programs as non-profit organizations performing community service in the local community, local government, local education programs, local athletic programs, local children programs, local business associations, local business loans, local beautification projects, and/or the like. Reinvesting the fee back into the community is a further example of how the bank-based advertising system increases community engagement and connects the bank to the local community. In this regard, in some embodiments of the invention, the bank-based advertising system is further configured to generate content created by the bank or other provider that shows the bank's investments and reinvestments into the local community.

In block 218, the bank-based advertising system provider stores the content in the bank-based advertising system database illustrated in block 220. As discussed previously with reference to block 120, the bank-based advertising system stores information relating to enrolled users, authorized users, user preferences, and content. In some embodiments, the bank-based advertising system database is updated with new content on an ongoing basis as the bank receives the content. For example, the bank-based advertising system database may be updated with content on a regular basis, as needed, on an ongoing basis, on a default schedule, on a predetermined schedule, or any other timeframe.

In some embodiments of block 218, the bank-based advertising system provider stores content that is received from a bank in the bank-based advertising system database. In some embodiments, the bank-based advertising system provides a content channel for the bank to present information, such as the bank's investment and reinvestment information described above. For example, the bank may desire to highlight the bank's involvement in the community and may therefore store content in the bank-based advertising system relating to that involvement. For example, a bank may support a local nonprofit and desire to inform the bank's customers of that support. In such an example, the bank provides content to the bank-based advertising system database and the content is presented in the same manner as user-inputted content.

In another embodiment, a bank-based advertising system provider can include content related to customers in the bank customer database. For example, a bank may include statistical analysis relating to a bank customer's financial transactions that would then be presented to that specific customer through the bank-based advertising system. In another example, the bank can include content relating to general statistical analysis of all customers or all customers in a particular community, such as average savings rate, average return on investment when investing with the bank, average sales in the community overall or by industry category or other category, or other statistics derived from the bank customer database. This content could be presented to specific individuals for whom the content is relevant, such as authorized content creating users of the bank-based advertising system, investors, business customers, and/or the like or it could be presented in public so that all bank customers could view the presentation. It should be understood that the types of content that a bank-based advertising system provider may store in a bank-based advertising system is not limited to the aforementioned examples and that other types of bank-provided content are possible.

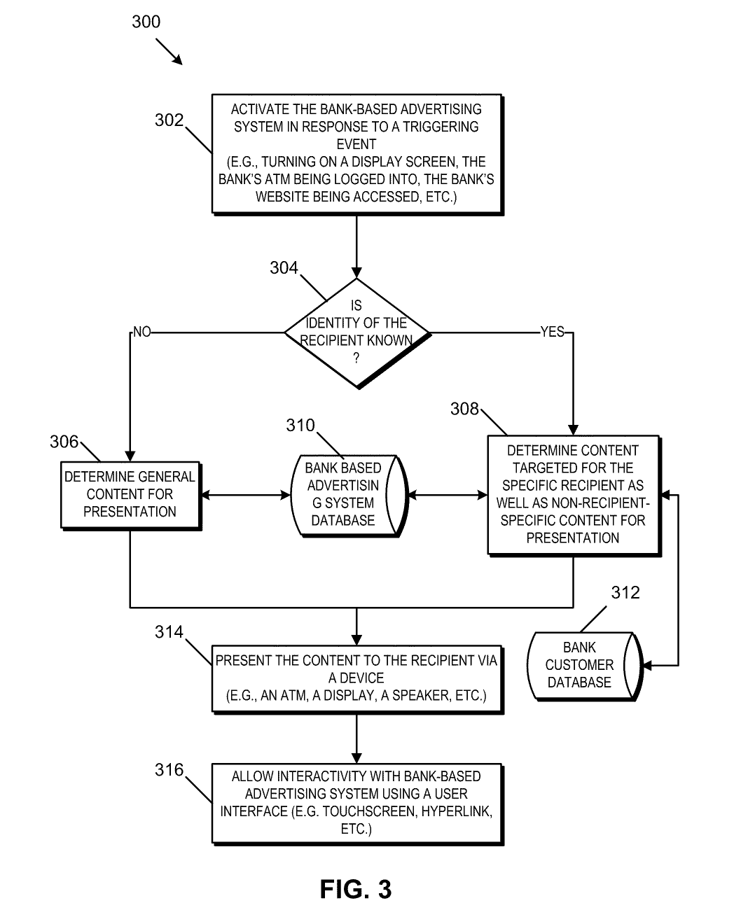

Turning now to FIG. 3, the method 300 illustrates an embodiment where the bank-based advertising system is activated and presents content to a recipient. A recipient is any person to which content is presented. A recipient can be a single individual, such as an individual logging into a website, or it can be multiple individuals, such as all individuals viewing an electronic display. In block 302, a bank-based advertising system is activated in response to a triggering event. In some embodiments, the triggering event is a recipient logging into a bank-associated device. For example, the bank-based advertising system may be activated when a bank customer logs into an ATM using his bank card or when a bank customer logs into a website. Other examples of activating a bank-based advertising system include turning on a personal digital assistant (PDA), smartphone, computer, mobile telecommunications device, an alerting device (e.g., a pager), or other electronic device that is connected to a bank network, either directly or wirelessly. In another embodiment, a bank-based advertising system is triggered when a presentation device is turned on. For example, a bank-based advertising system may be triggered when an electronic bulletin board in a bank lobby is turned on. Additional examples of triggering events for activating a bank-based advertising system include a request of a bank customer, a bank customer being identified based on sensors, upon a reaching a particular time of day, or any other means.

Turning now to decision block 304, the bank-based advertising system determines whether the identity of the recipient is known. In some embodiments, the identity of the recipient is known based on bank authentication methods. For example, when a recipient logs into an ATM the recipient's identity is known. In another embodiment, the methods of authenticating a user's identity may also be used to determine the identity of the recipient. Website login, networked mobile devices, and biometrics such as fingerprint or retinal scan, are all examples of methods of identifying a recipient of content. In some embodiments, the identity of the recipient is not known. For example, the identities of viewers of an electronic bulletin board in a bank lobby may not be known. Other examples where a recipient's identity may not be known include when a recipient is detected based on certain types of sensors, such as a motion sensor or heat sensor, or when a recipient cannot be identified from standard techniques, such as improperly functioning facial recognition software. In the illustrated embodiment, if the identity of the recipient is not known, the method for a bank-based advertising system proceeds to block 306. However, in some embodiments, if the identity of the content recipient is known, the method for a bank-based advertising system proceeds to block 308.

In block 306, general content is determined for presentation. The content is stored in the bank-based advertising system database, as illustrated in block 310. The content may be user-inputted content or it may be bank-provided content. In some embodiments, content is determined based on the characteristics of the presentation. The characteristics of the presentation may include the location where the content is presented, the method by which the content is presented, the time that the presentation is occurring, and other characteristics of the presentation. For example, content being presented in a small town may be preferentially related to businesses in that town. In another example, content being presented in a small town may be content related to the bank's community involvement in that town.

In some embodiments, content is determined based on the characteristics of the content. Characteristics of the content may include user-inputted preferences regarding presentation manner or subject matter. For example, a user may input content and specify that the content should only be displayed in ATM's in a specific city. While that content is included in the bank-based advertising system database, it will not be determined for presentation by methods other than those selected by the user. Further examples that influence whether content is determined for presentation include the content's start date, the content's end date, the maximum fee the user is willing to pay for presentation, or other characteristics of the content that can influence whether it is appropriate for presentation.

In some embodiments of the invention, the bank may determine appropriate content for presentation based on bank-specific data. For example, a bank may determine content for presentation in a bank branch based on bank-specific data relating to all of the customers that have accounts at that branch. In this example, the bank may display general statistical analysis describing all of the customers, or a subset of customers, of the bank branch through the bank-based advertising system. Other examples of a bank determining general content for presentation based on bank-specific data include profiles of bank customers, information on the bank's involvement in a community based on a determination that the involvement would be of interest to the community (e.g., determining that many customers at a bank branch give money to the Salvation Army based on account transactions and therefore determining content related to the bank's support of the Salvation Army), or other methods of determining content based on bank-specific data. It should be understood that the examples of the determination process for content presentation listed herein are not limiting and that other examples are possible, for example content may be selected randomly, sequentially based on input date, based on fee structure, or based on other characteristics of the content in the bank-based advertising system database.

Turning now to block 308, content is determined for presentation based on general characteristics of the content, as described previously with regards to block 306, and also based on the identity of the recipient. In some embodiments, information about the recipient is determined in connection with the bank customer database, as illustrated in block 312. For example, information on the recipient's financial transactions may be provided to the bank-based advertising system to assist in determining content based on the identity of the recipient. In an embodiment, the bank-based advertising system determines what should be displayed in the bank-based advertising system in accordance with recipient-defined settings and preferences. In another embodiment, a determination of content is made based on default rules, which may or may not be customizable by the recipient. In yet another embodiment, content is determined by comparing the recipient to bank customers in the bank customer database. For example, a recipient of content may have account information or transactions that indicate that the recipient is appropriate for a certain type of content. A recipient may have a small business account and therefore content appropriate for small business accounts may be preferentially determined for presentation to that recipient. Content appropriate for small business accounts may be determined based on information in the bank customer database, such as that other small businesses and the database have been associated with the content, e.g., that small businesses have financial transactions indicating use of the service advertised in the content.

In another example, a recipient's transactions, such as donation to a local nonprofit determined through the bank customer database, may influence the determination of content. A bank may preferentially present content related to its involvement with that local nonprofit to that identified recipient. It should be understood that the identity of the recipient may be used in conjunction with the bank customer database in many ways to determine targeted or personalize content for the recipient. The examples mentioned herein do not limit the methods for increasing community engagement by presenting content about the bank's involvement in the community and providing a service to the bank's customers through a targeted media channel.

In block 314, the bank-based advertising system presents content to the recipient. In some embodiments, the bank-based advertising system is presented in a browser, such as an internet browser or any browser on an operating system. In a further embodiment, the user links the bank-based advertising system to one or more computer programs, such as Microsoft® Outlook and Google Calendar®. Other embodiments include presenting the bank-based advertising system on an ATM, an electronic bulletin board, a personal digital assistant (PDA), smartphone, computer, mobile telecommunications device, an alerting device (e.g., a pager), or other electronic device. Further, portions of the bank-based advertising system can be presented to the user via a user's mobile device (e.g., PDA, mobile phone, etc.), via an email message, Short Messaging Service (SMS) text message, Multimedia Messaging Service (MMS) text message, a wireless networked connection, a telephone call to the user, a voice message, or any other method of presenting information to the user via the user's electronic devices. The bank-based advertising system can be presented to the user in a visual format, audibly, any combination thereof or by any other method. It should be understood that a variety of ways of presenting the bank-based advertising system to the user are well within the scope of the present invention, and the previously-mentioned examples and embodiments are not intended to limit the method of presentation of the bank-based advertising system.

Turning now to block 316, some embodiments of the bank-based advertising system allows interactivity with the recipient. For example, in some embodiments, a recipient is allowed to interface with the system. Examples of interaction with the bank-based advertising system include uploading information to the system, requesting more information regarding the content, requesting that the content be changed, adjusting recipient settings and preferences, or other types of input. Examples of a recipient requesting more information regarding the content include requesting contact information, requesting a map to the location mentioned in the content, requesting to enroll in the bank service profiled in the content, donating money to the nonprofit organization mentioned in the content, printing the advertisement or a coupon or flier associated therewith, or making a purchase through the advertisement in the content.

In some embodiments where the bank-based advertising system permits the recipient to make a purchase or other payment to the entity identified in the content, the bank-based advertising system allows the payment to be automatically withdrawn from the recipient's bank account. For example, where a recipient has logged into an ATM and the ATM is used to display content from the bank-based advertising system, the recipient may be able to quickly purchase the advertised product because the recipient is already authenticated to the bank.

In some embodiments, a recipient is also a user (e.g., content creator) of the bank-based advertising system. In this embodiment, the recipient/user is presented content and also is able to upload or modify his/her own content.

In some embodiments, the bank-based advertising system receives recipient input and can respond to the input. For example, the response may include an answer to a recipient's question, additional information, new content, enrollment in a bank service, or any other type of communication that is responsive to the recipient's input.

In some embodiments, the bank-based advertising system is an online product such that the user enrolls into an online account and one or more graphical user interfaces (GUIs) of the bank-based advertising system is generated and presented to the user by the online product. For example, the above described methods may be embodied in an online banking system where a user that has a financial account with a bank logs into the user's online account. Once the user logs into the user's account, the bank-based advertising system (or a portion thereof) can be accessed by the user via the online banking system.

The bank-based advertising system is created to perform the above-described methods. Embodiments of the bank-based advertising system (or portions thereof) can receive the user content for presentation, store the content and personalize presentation instructions in a database, and present the content to recipients, as previously discussed. For example, when logging into an online banking site, the user can view the user's bank-based advertising system, where the user can authenticate his identity by a secure login and upload personalized content about his small business and personalize the presentation details based on location, method of presentation, and method of payment. The system presents the user's content in accord with his preferences and acts as a personalized media channel for the community.

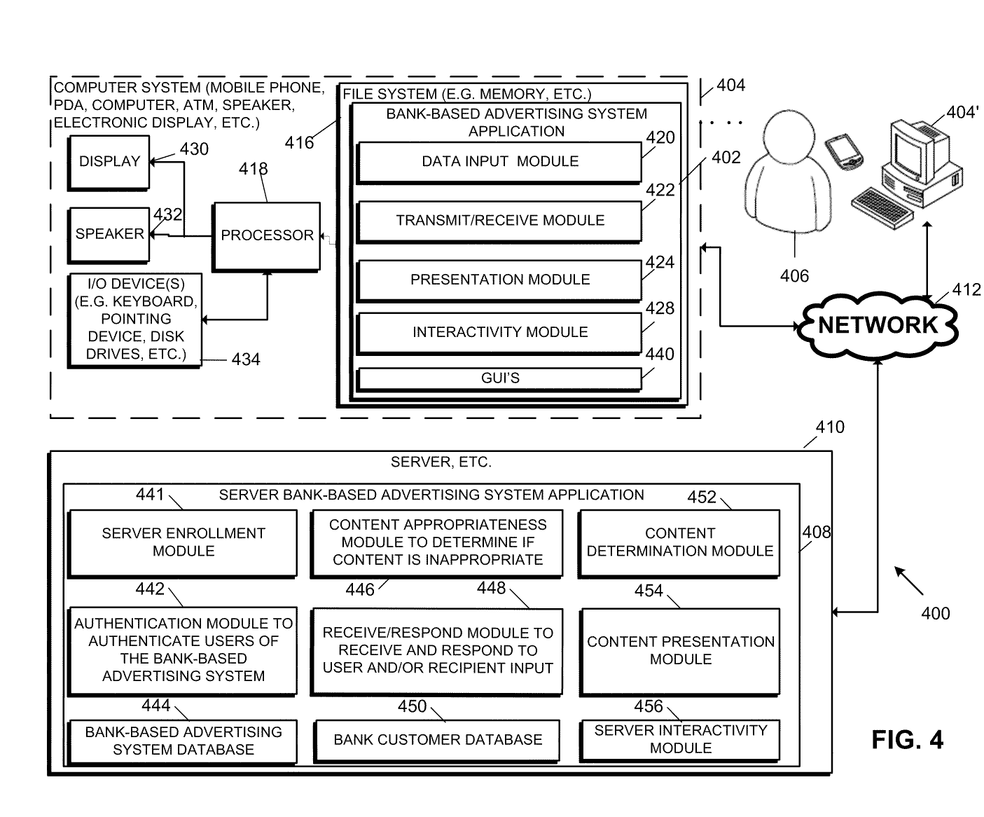

Alternatively or additionally, some embodiments of the bank-based advertising system (or portions thereof) can receive bank-provided content, store the content in the bank-based advertising system database, and present the content to recipients. Content may be personalized for the recipient of the content based on bank-specific data about the recipient. The components and operations of some embodiments of the online product are described below with regard to FIG. 4.

FIG. 4 is a block schematic diagram of an example of a system 400 for a bank-based advertising system in accordance with some embodiments of the invention. The system 400 includes a bank-based advertising system application 402 operable on a computer system 404 or similar device of a user 406 or a client 404′. In some embodiments, some or all of the bank-based advertising system application 402 is downloaded to or otherwise stored on the user's computer system 404 as shown in FIG. 4, however, in other embodiments of the invention, some or all of the bank-based advertising system application 402 resides on the server 410 and is accessed by the computer system 404 using a browser application, such as a web browser, stored in the computer's memory 416.

In addition to the bank-based advertising system application 402 on the user's computer system 404 or client 404′, the system 400 includes a bank-based advertising system server application 408 operable on a server 410 and accessible by the user 406 or client 404′ via a network 412. The previously discussed methods 100-300 are embodied or performed by the bank-based advertising system application 402 or the bank-based advertising system server application 408. For example, the methods 100-300 may be performed by the bank-based advertising system application 402. In another embodiment, the methods 100-300 are performed by the bank-based advertising system server application 408. In a further embodiment of the present invention, some of the features or functions of the methods 100-300 are performed by the bank-based advertising system application 402 on the user's computer system 404 and other features or functions of the methods 100-300 are performed on the bank-based advertising system server application 408.

The network 412 is the Internet, a private network, or other network. Each computer system 404′ is similar to the exemplary computer system 404 and associated components as illustrated in FIG. 4.

The bank-based advertising system application 402 and/or bank-based advertising system server application 408 is a self contained system with imbedded logic, decision making, state based operations and other functions that operate a bank-based advertising system product.

The bank-based advertising system application 402 is stored on a file system 416 or memory of a computer system 404. The bank-based advertising system application 402 may be accessed from the file system 416 and run on a processor 418 associated with the computer system 404.

The bank-based advertising system application 402 includes a data input module 420. The data input module 420 allows for entry of user information such as enrollment information, preferences, and updates. The data input module 420 also allows input of content and preferences regarding content presentation. The data input module 420 is accessed or activated whenever the user 406 indicates a desire to activate the bank-based advertising system and calls other modules such as the graphical user interface 440, as described below.

The bank-based advertising system application 402 also includes a transmit/receive module 422. At this point, the input of user information from the computer 404 is transmitted to the bank-based advertising system application 408 on the server 410 via the network 412. The input of user information can include enrollment information, user-inputted data regarding preferences, new or modified content, and the like inputted from the data input module 420 or information obtained via a different module. The transmit/receive module 422 allows a user or recipient to receive information from the bank-based advertising system server application 408 on the server 410. This information can be content, data regarding content presentation, a GUI to modify existing content or preferences, other information to be presented in the bank-based advertising system, or other information related to the functioning of the bank-based advertising system.

The bank-based advertising system application 402 also includes a presentation module 424. The presentation module 424 presents the bank-based advertising system to the user so that the user may upload or modify his content in the bank-based advertising system. The presentation module 424 also presents the content to a recipient. The presentation module 424 presents the bank-based advertising system in a browser, other software product via a PDA, smart phone, other computing device, or other similar electronic media.

The bank-based advertising system application 402 includes an interactivity module 428. The interactivity module 428 allows a user to transmit back to the server 410 a response to the content. The user is able to indicate a desire to enroll in the recommended product or service, request more information about the content, change the content, respond to an alert presented, or perform other functions which require communications between the computer 404 and the server 410.

The user's computer system 404 includes a display 430 and speaker 432. Any graphical user interfaces 440 associated with the bank-based advertising system server application 408 is presented on the display 430. The user's computer system 404 also includes one or more input devices, output devices or combination input and output devices, collectively I/O devices 434. The I/O devices 434 includes a keyboard, computer pointing device, touch screen, touch pad, or similar devices to control input of information as described herein. The I/O devices 434 also include disk drives or devices for reading computer media including computer readable or computer operable instructions.

The bank-based advertising system application 402 presents content and other desired information of the bank-based advertising system product to the user 406, such as by presenting the current status information to a display 430, storing the results in the file system 416, etc.

The bank-based advertising system server application 408 includes a server enrollment module 441. The server enrollment module 441 performs functions related to identifying an initial user, including receiving data from the bank customer database 450, and enrolling the user in the bank-based advertising system. The module also determines other authorized users and user preferences relating to content. The server enrollment module 441 determines whether any of the authorized users are inappropriate and offers the user an opportunity to modify the users so that they are appropriate, such as enrolling them in bank authentication methods. The server enrollment module 441 links the bank-based advertising system server application 408 on the server 410 to modules on the user's computer 404 and internal data sources, such as a bank database 450.

The bank-based advertising system server application 408 also includes an authentication module 442. The authentication module 442 determines if a user of the bank-based advertising system is authorized to upload or change content in the bank-based advertising system. The authentication module 442 operates by interacting with the bank customer database 450 and the bank-based advertising system database 444.

The bank-based advertising system server application 408 also includes a bank-based advertising system database 444. The bank-based advertising system database 444 includes any stored information related to user enrollment information and user data, such as content presentation preferences, content, and any other information associated with the bank-based advertising system product.

The bank-based advertising system server application 408 additionally includes a content appropriateness module 446. The content appropriateness module 446 determines if the content is appropriate for presentation through the bank-based advertising system. The content appropriateness module 446 determines if content is appropriate based on subject matter, targeted communities, targeted recipients, duration, or any other characteristic of the content that may be evaluated for appropriateness. The content appropriateness module 446 connects to the bank-based presentation module 424 on the computer 404 if the content is inappropriate and allows the user 406 to modify the content to make it appropriate. In some embodiments, the content appropriateness module 446 suggests ways to modify the content to make it appropriate in connection with the bank customer database 450.

The bank-based advertising system server application 408 additionally includes a receive/respond module 448. The receive/respond module 448 receives user input from the data input module 420 on the computer 404 over the network 412. The input can be enrollment information, new content, modified content, modified preferences, or any other input relating to creating, maintaining, and providing a bank-based advertising system. The receive/respond module 448 allows the server bank-based advertising system application 408 to identify the recipient of content by receiving the recipient's log-in information and connecting to the bank customer database 450. The receive/respond module 448 also allows the bank-based advertising system server application 408 to respond to the user input, such as by connecting with the presentation module 422 on the computer 404 over the network 412.

The bank-based advertising system server application 408 yet further includes a bank customer database 450. The bank customer database 450 includes any stored information owned by and related to bank users, such as user transaction information, user balance information, user demographic information, and the like. The bank customer database 450 is used in connection with the content presentation module 452 in the bank-based advertising system server application 408.

The bank-based advertising system server application 408 also includes a content determination module 452. The content determination module 452 determines content for presentation in the bank-based advertising system. The content determination module 452 may determine general content for presentation or it may determine content for presentation based, at least in part, on the identity of the recipient of the content. The content determination module 452 interacts with other modules on the server 410, such as the bank-based advertising system database 444, the bank customer database 450, and the receive/respond module 448.

The bank-based advertising system server application 408 also includes a content presentation module 454. The content presentation module 454 presents content to a recipient. The content presentation module 454 operates by interacting over the network 412 with the presentation module 424 on the computer 404. The content presentation module 454 performs operations similar to the presentation module 424 on the user's computer 404, as previously discussed. However, the content presentation module 454 performs the operations on the server 410 and communicates with other modules on the server 410, such as the bank-based advertising system database 444.

The bank-based advertising system server application 408 also includes a server interactivity module 456. The server interactivity module 456 functions by receiving and responding to input from a recipient of content. The server interactivity module 456 then provides a response to the recipient's input. The server interactivity module 456 interacts with other modules on the server 410, including the receive/respond module 448, the content presentation module 454, and the bank customer database 450.

The bank-based advertising system application 402, 408 includes graphical user interfaces 440, as previously mentioned. The bank-based advertising system application 402 and/or bank-based advertising system server application 408 allows one or more predetermined graphical user interfaces 440 to be presented to the user 406 in order for the user 406 to input data or information into the system 400. The graphical user interfaces 440 are predetermined and/or presented in response to the user 406 indicating the user 406 would like to perform a task associated with the bank-based advertising system, such as setting up display preferences, inputting user data and content, modifying content, allowing other inputs, presenting information to the user and financial institution, etc. The predetermined graphical user interfaces 440 are generated by the bank-based advertising system application 402 and/or bank-based advertising system server application 408 and are presented on the display 430 at the computer system 404. Graphical user interfaces 440 also include graphical user interfaces that permit the user 406 to view the bank-based advertising system and query any of the databases and/or generate reports and/or respond to content.

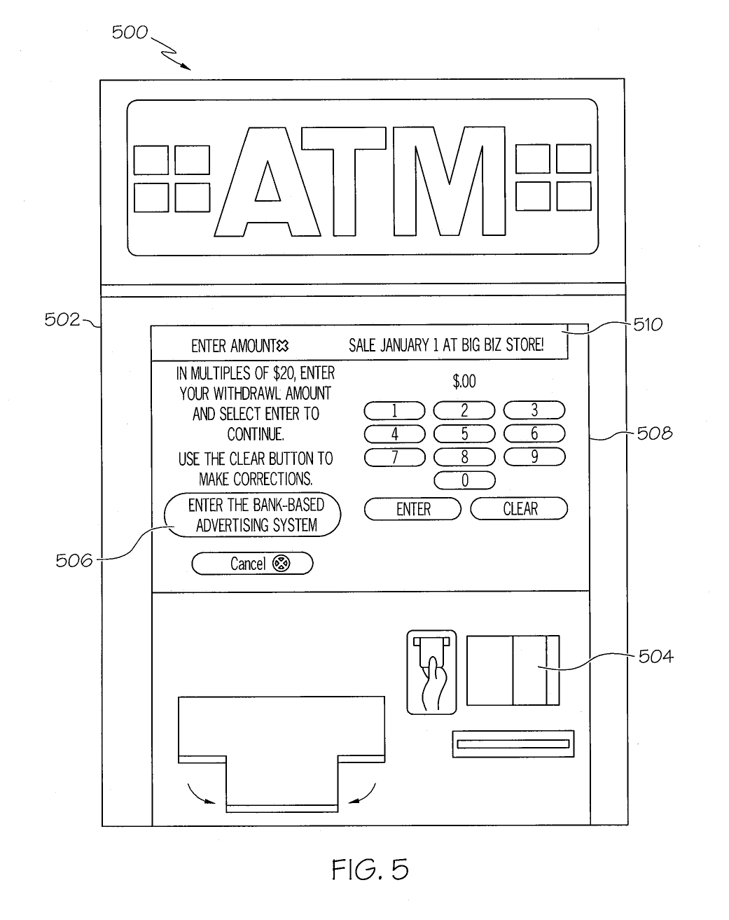

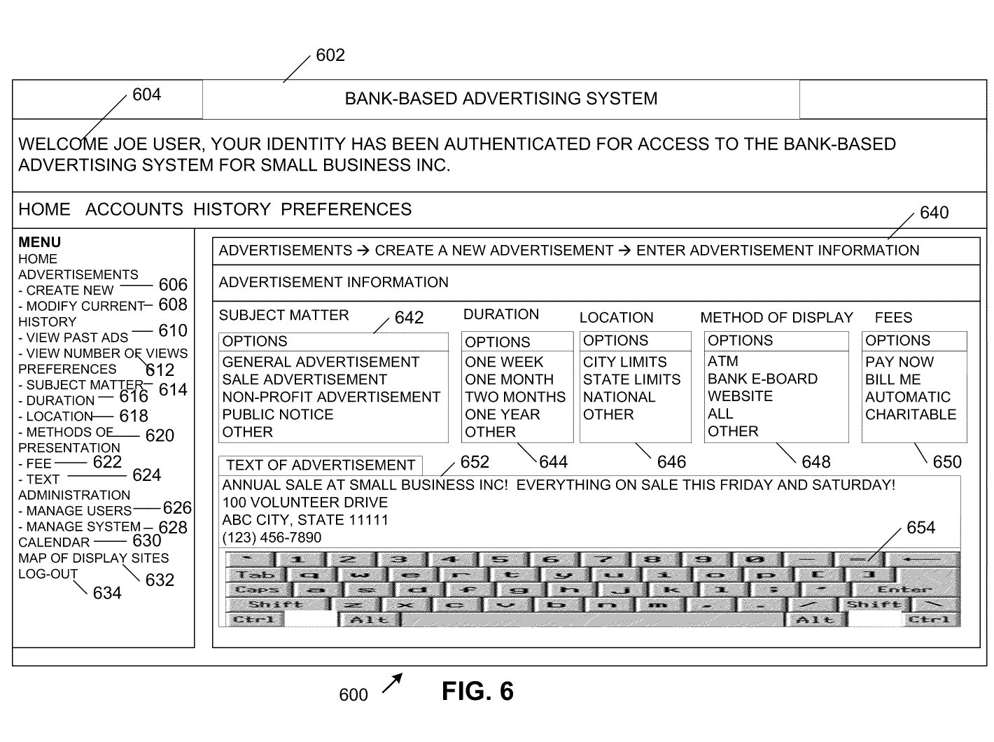

FIG. 5 is an exemplary embodiment of a bank-based advertising system presented to a user in accordance with the embodiments of the invention described above with regard to FIGS. 1-4. The bank-based advertising system 500 is illustrated, in this example, as displayed on an ATM 502. The bank-based advertising system has a method of authenticating a user's identity, here via bank card reader 504. After authentication, a user is able to enter the bank-based advertising system through an entry portal 506. In some embodiments, the entry portal 506 can lead to a GUI (see FIG. 6). In this example, a digital display 508 allows operation of the bank-based advertising system. Further, the bank-based advertising system may present content 510 to a user at an ATM. This content may be user content or bank content. The bank-based advertising system 500 also allows normal banking operations at the ATM 502 to continue, such as withdrawing funds from the ATM.

FIG. 6 is another exemplary embodiment of a method for a bank-based advertising system 600 presented to a user through a GUI 602 in accordance with the embodiments described above with regard to FIGS. 1-4. The bank-based advertising system GUI 602 presents customization options to an authorized user 604. In some embodiments, the bank-based advertising system GUI 602 includes a menu with a variety of customization options. These options include the ability to create new content for presentation 606 or modify current content 608. Other options include viewing the user's history with the bank-based advertising system, such as viewing past content 610 or receive data on the number of times the content has been presented 612. Further, in some embodiments a user is able to modify general preferences relating to all or portions of content uploaded by the user. For example, the user may determine preferences for allowable subject matter 614, duration 616, location for presentation 618, methods of presentation 620, general fee preferences 622, or preferences relating to the text of any content 624. Also, a user may administer the bank-based advertising system via the GUI 602. For example, the user may manage authorized users of the bank-based advertising system 626, such as adding authorized users, removing authorized users, or setting different levels of access for authorized users. The user may also manage the entire system 628, including cancelling the user's enrollment in the system, transferring the system to someone else, etc. In yet more embodiments, the user provides or receives information relating to the time and/or date when content has been or should be presented 630, or the locations where content has been or should be presented 632. Further, the GUI provides an option for a user to log-out of the bank-based advertising system 634 so that unauthorized users are unable to upload or modify content.

In an embodiment of a bank-based advertising system 600 illustrated in FIG. 6, a user is also able to upload content for presentation 640, including specific customization options for the content. Customization options include the subject matter of the content 642, the duration that the content should be displayed 644, the location where the content should be displayed 646, the method of display 648, how the fee will be paid 650, and the text of the content 652. A user interface such as a keyboard 654 is provided in some embodiments. The bank-based advertising system 600 described and illustrated in FIG. 6 is only meant to be directed to some embodiments and other embodiments are within the scope of the present invention based on the disclosure provided herein.

In some embodiments, the bank-based advertising system also includes or provides access to a bank-based business review forum, where authenticated bank customers can go to rate and review businesses. U.S. patent application Ser. No. ______ to Nagarajan et al., entitled “Community Hub Review,” and filed concurrently herewith, describes such a bank-based business review forum in greater detail and is hereby incorporated by reference in its entirety.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

The terminology used herein is for the purpose of describing particular embodiments only and is not intended to be limiting of the invention unless the context clearly indicates otherwise. As used herein, the singular forms “a,” “an,” and “the” are intended to include the plural forms as well, unless the context clearly indicates otherwise. It will be further understood that the terms “includes,” “has,” “comprises,” “including,” having,” and/or “comprising,” when used in this specification, specify the presence of stated features, integers, steps, operations, elements, and/or components in the stated embodiment, but do not preclude the presence or addition of one or more other features, integers, steps, operations, elements, components, and/or groups thereof

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for providing a bank-based advertising system, the apparatus comprising:
an input interface configured to receive input;
an output interface configured to provide output;
a memory system comprising authentication information for a plurality of customers of a bank, wherein the authentication information for a customer includes information that the customer can use to authenticate the customer's identity when the customer attempts to access a financial account associated with the customer and maintained by the bank; and
a processor operatively coupled to the input interface, the output interface, and the memory system, wherein the processor is configured to:
use the input interface to receive an authentication request from the user,
compare information received with the authentication request to authentication information stored in the memory system to determine that the user is a customer of the bank that is authorized to use the bank-based advertising system,
allow the user to create an advertisement using the bank-based advertising system, and
present the advertisement to others using the output interface.

2. The apparatus of claim 1, wherein the information received with the authentication request comprises a user identification code and a passcode, and wherein the processor is configured to compare the user identification code and the passcode to a user identification code and passcode that the user can use to access the user's financial account online.

3. The apparatus of claim 1, wherein the information received with the authentication request comprises information read from a payment device held by the user.

4. The apparatus of claim 1, wherein the processor is further configured to:
use the output interface to provide the user with a graphical user interface comprising an advertisement creation tool.

5. The apparatus of the claim 4, wherein the advertisement creation tool comprises a tool for allowing the user to upload content for the advertisement.

6. The apparatus of the claim 4, wherein the advertisement creation tool comprises a tool for allowing the user to specify an audience for the advertisement.

7. The apparatus of the claim 4, wherein the advertisement creation tool comprises a tool for allowing the user to specify a geographic region in which the advertisement is to be presented.

8. The apparatus of claim 1, wherein the processor is further configured to:
determine a community associated with the advertisement; and
use the output interface to present the advertisement to the community.

9. The apparatus of claim 8, wherein the community associated with the advertisement comprises a geographic region, and wherein the processor is configured to use the output interface to present the advertisement to the community by presenting the advertisement using presentation devices located within the geographic region.

10. The apparatus of claim 8, wherein the community associated with the advertisement comprises a group of bank customers.

11. The apparatus of claim 8, wherein the processor is configured to determine the community associated with the advertisement based at least partially on user input.

12. The apparatus of claim 8, wherein the processor is configured to determine the community associated with the advertisement based at least partially on transaction data maintained by the bank.

13. The apparatus of claim 1, further comprising:
a plurality of display devices located at a plurality of banking centers and communicably coupled to the output interface, wherein the processor is configured to present the advertisement to others using the output interface by presenting the advertisement using at least some of the plurality of display devices.

14. The apparatus of claim 1, wherein the processor is configured to present the advertisement to others using the output interface by displaying the advertisement on an automated teller machine display, a bank website, an electronic bank statement, a paper bank statement, or an electronic bulletin board located in a bank branch.

15. The apparatus of claim 1, wherein the advertisement comprises a notice, offer, promotion, sale, coupon, or discount.

16. The apparatus of claim 1, wherein the processor is configured to compare the advertisement to a plurality of rules to determine whether the advertisement contains inappropriate content.

17. The apparatus of claim 1, wherein the processor is further configured to:
determine that the information associated with the authentication request authorizes the user to access a business account associated with a business, and
allow the user to create an advertisement on behalf of the business based at least partially on the determination that the information associated with the authentication request authorizes the user to access a business account.

18. The apparatus of claim 17, wherein the processor is further configured to:
receive user input from the user, the user input comprising an indication of one or more other bank customers, and
allow, based at least partially on the user input, the one or more other bank customers to create or modify an advertisement on behalf of the business based on the user input.

19. The apparatus of claim 1, wherein the processor is further configured to:
receive user input from the user, the user input comprising an indication of a time period for presenting the advertisement, and
use the output interface to present the advertisement based at least partially on the indication of the time period for presenting the advertisement.

20. The apparatus of claim 1, wherein the processor is further configured to assess a fee for presenting the advertisement.

21. The apparatus of claim 20, wherein the processor is further configured to determine the fee based on a number of times or length of time that the advertisement is presented, viewed, or accessed.

22. The apparatus of claim 1, wherein the processor is further configured to:
use the input interface to receive input from a recipient of the advertisement, and
use the output interface to provide the recipient with additional information associated with the advertisement in response to the input received from the recipient.

23. A computer-implemented method comprising:
receiving an authentication request from a user;
comparing information received with the authentication request to authentication information stored in a memory system to determine that the user is a customer of the bank and has access to a financial account maintained by a bank;
providing the user with access to a bank-based communication system based at least partially on the determination that the user is a customer of the bank and has access to the financial account;
allowing the user to use the bank-based communication system to create content on behalf of an owner of the financial account; and
presenting the content to one or more other bank customers.

24. The computer-implemented method of claim 23, wherein the bank-based communication system comprises a bank-based advertisement, and wherein the content comprises an advertisement.

25. The computer-implemented method of claim 23, wherein the financial account comprises a business account, and wherein allowing the user to use the bank-based communication system to create content on behalf of the owner of the financial account comprises:
allowing the user to use the bank-based communication system to create content on behalf of a business associated with the business account.

26. The computer-implemented method of claim 23, wherein providing the user with access to the bank-based communication system comprises:
providing the user with a graphical user interface comprising an advertisement creation tool.

27. The computer-implemented method of claim 23, further comprising:
determining a community associated with the communication; and
presenting the advertisement to the community.

28. The computer-implemented method of claim 27, wherein the community associated with the communication comprises a geographic region, and wherein the method comprises presenting the communication through presentation devices located within the geographic region.

29. The computer-implemented method of claim 27, wherein the community associated with the communication specifies a group of bank customers, and wherein the method comprises presenting the communication to the group of bank customers.

30. The computer-implemented method of claim 27, comprising:
determining the community associated with the communication based at least partially on transaction data maintained by the bank.

31. The computer-implemented method of claim 23, comprising:
displaying the communication on an automated teller machine display, a bank website, an electronic bank statement, a paper bank statement, or an electronic bulletin board located in a bank branch.

32. The computer-implemented method of claim 23, further comprising:
receiving user input from the user, the user input comprising an indication of a time period for presenting the communication; and
presenting the communication based at least partially on the indication of the time period for presenting the communication.

33. The computer-implemented method of claim 23, further comprising:
receiving input from a recipient of the communication; and
providing the recipient with additional information associated with the communication in response to the input received from the recipient.

34. A computer program product comprising a non-transitory computer readable medium having computer executable program code embodied therein to provide a bank-based advertising system, the computer executable program code comprising:
a computer executable code portion configured to receive an authentication request from a user;
a computer executable code portion configured to compare information received with the authentication request to authentication information stored in a memory system to determine that the user is a customer of the bank and has access to a financial account maintained by a bank;
a computer executable code portion configured to provide the user with access to a bank-based communication system based at least partially on the determination that the user is a customer of the bank and has access to the financial account;
a computer executable code portion configured to allow the user to use the bank-based communication system to create content on behalf of an owner of the financial account; and
a computer executable code portion configured to present the content to one or more other bank customers.

35. The computer program product of 34, wherein the bank-based communication system comprises a bank-based advertisement, and wherein the content comprises an advertisement.

36. The computer program product of 34, wherein the financial account comprises a business account, and wherein computer executable program code comprises:
a computer executable code portion configured to allow the user to use the bank-based communication system to create content on behalf of a business associated with the business account.

37. The computer program product of 34, further comprising:
a computer executable code portion configured to determine a community associated with the communication; and
a computer executable code portion configured to present the advertisement to the community.

38. The computer program product of 37, wherein the community associated with the communication comprises a geographic region, and wherein computer executable program code comprises:
a computer executable code portion configured to present the communication through presentation devices located within the geographic region.

39. The computer program product of 37, wherein the community associated with the communication specifies a group of bank customers, and wherein computer executable program code comprises:
a computer executable code portion configured to present the communication to the group of bank customers.

40. The computer program product of 37, further comprising:
a computer executable code portion configured to determine the community associated with the communication based at least partially on transaction data maintained by the bank.

41. The computer program product of 34, further comprising:
a computer executable code portion configured to display the communication on an automated teller machine display, a bank website, an electronic bank statement, a paper bank statement, or an electronic bulletin board located in a bank branch.
